(19) United States
(12) Patent Application Publication
(10) Pub. No.: US 2006/0248547 A1
(43) Pub. Date: Nov. 2, 2006

(54) Multi-level cache apparatus and method for enhanced remote invocation performance

(75) Inventors: A. Joseph Bockhold, Rochester, MN (US); Jinmei Shen, Rochester, MN (US); Hao Wang, Rochester, MN (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/106,003

(22) Filed: Apr. 14, 2005

(51) Int. Cl. G06F 9/46; G06F 9/44; G06F 13/00

(52) U.S. Cl. 719/330

(57) ABSTRACT

In a networked computer system, partitioned proxies are defined that each include a cache of connection information that allows for quickly routing a remote invocation to an object without suffering the overhead of determining routing information for the object each time the object is remotely invoked. Multiple copies of an object are created in multiple computer systems. A partitioned proxy is then created that points to each copy of the object. The partitioned proxies allow quickly accessing these object copies without the overhead of synchronizing their state data. Caching connection information within the partitioned proxies allows a computer system to invoke a remote object without the performance penalty of determining with each invocation the connection information for accessing the remote object.

### BACKGROUND OF THE INVENTION

1. Technical Field

This invention generally relates to computer systems, and more specifically relates to remote invocation of objects in a networked computer system.

2. Background Art

Networked computer systems allow different computers to communicate with each other. The Internet is one example of a networked computer system that links millions of computers together. Of course, there are a large number of other types of computer networks as well. The goal of most computer networks is to allow computers to communicate with each other. One known way for computers to communicate uses a concept referred to as remote invocation.

Remote invocation refers to the ability for one computer system to execute (or invoke) an object on a different computer system. Remote invocation of objects is very common in today's networked computer systems because the ability to remotely invoke objects improves the scalability, availability and flexibility of the system. Remote invocation typically uses an object known as a “proxy” for remotely invoking an object. The proxy is usually a “stub” that does not contain the needed logic, but simply contains routing information that points to the remote object that contains the needed logic. In simple prior art systems, a proxy in a first computer system is called to invoke an object in a second computer system. This method works well when there is a single remote object. However, many networked computer systems now include multiple copies of an object in different computer systems. The performance cost of synchronizing the state of these multiple copies is high, and becomes a significant drain on system resources as the number of copies increases.

The concept of a “cluster” of computer systems has grown in popularity in recent years. Modern networked computer systems may include multiple clusters. The remote invocation of objects becomes more difficult in the presence of multiple clusters, because the scope of an object now needs to be greater than the scope of a single cluster. This requires sophisticated schemes for synchronizing objects across clusters, which is a significant drain on system resources. Without a way to improve the performance of remote invocations in a networked computer system, the computer industry will continue to suffer from excessive overhead in managing remote invocations when multiple clusters are present.

### DISCLOSURE OF INVENTION

In a networked computer system, partitioned proxies are defined that each include a cache of connection information that allows for quickly routing a remote invocation to an object without suffering the overhead of determining routing information for the object each time the object is remotely invoked. Multiple copies of an object are created in multiple computer systems. A partitioned proxy is then created that points to each copy of the object. These copies of the object need not have their state data synchronized because they handle different types of requests, and therefore need not access the same state data. The partitioned proxies allow quickly accessing these object copies without the overhead of synchronizing their state data. The preferred embodiments thus provide the advantage of multiple copies of an object in remote systems that may span multiple computer clusters without the performance penalty of synchronizing the state of the multiple copies. Caching connection information within the partitioned proxies allows a computer system to invoke a remote object without the performance penalty of determining with each invocation the connection information for accessing the remote object.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art networked computer system;

FIG. 2 is a prior art table showing the correlation of object delegates to corresponding proxy objects;

FIG. 3 is a block diagram of a prior art networked computer system that includes multiple copies of an object;

FIG. 4 is a flow diagram of a prior art method for routing a remote invocation to the corresponding object;

FIG. 5 is a block diagram of a prior art partitioned computer system;

FIG. 6 is a block diagram of a partitioned computer system that includes partitioned proxies in accordance with the preferred embodiments;

FIG. 7 is a block diagram of the partitioned computer system that includes partitioned proxies in accordance with the preferred embodiments;

FIG. 8 is a flow diagram of a method for partitioning proxies in accordance with the preferred embodiments;

FIG. 9 is a flow diagram of a method for routing a remote object invocation in accordance with the preferred embodiments;

FIG. 10 shows a table for the first level of the multi-level cache in accordance with the preferred embodiments;

FIG. 11 shows a table for the second level of the multi-level cache in accordance with the preferred embodiments; and

FIG. 12 shows contents of a partitioned proxy object in accordance with the preferred embodiments.

### BEST MODE FOR CARRYING OUT THE INVENTION

1.0 Overview

The present invention relates to the remote invocation of objects in a networked computer system. For those not familiar with remote invocation of objects, this Overview section will provide background information that will help to understand the present invention.

### Known Remote Invocation of Objects

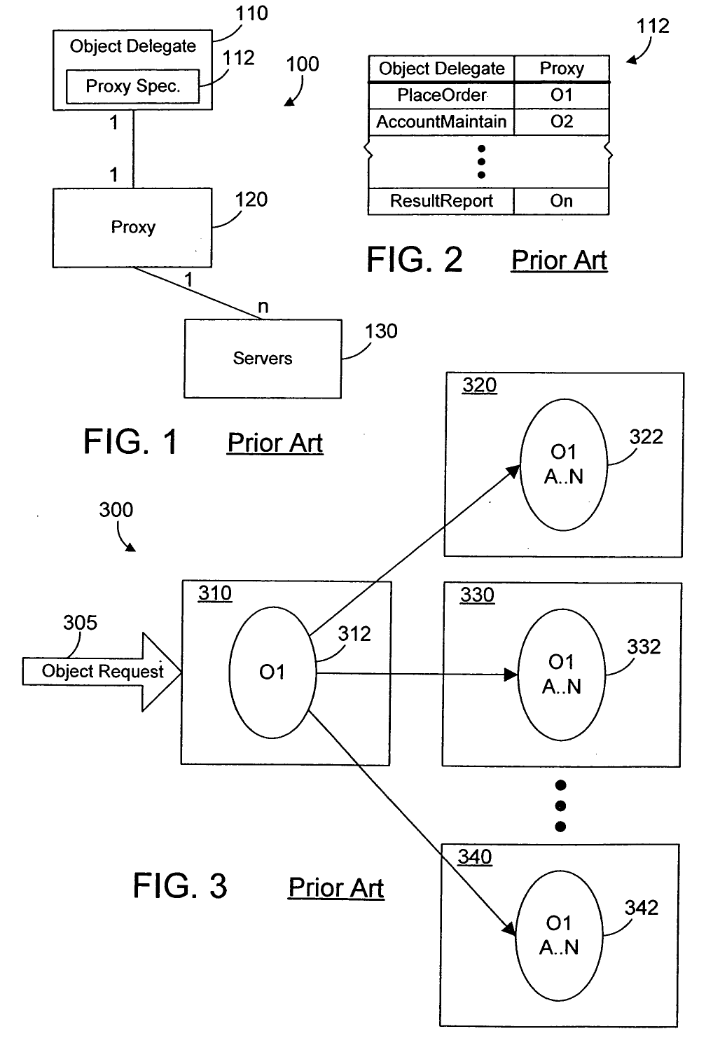

One known computer system that supports remote invocation of objects is shown in FIG. 1. An object delegate 110 resides on a client computer system. The object delegate 110 includes a proxy specification 112 that identifies which proxy to use. For each object delegate 110, there is one and only one proxy 120. The proxy 120 may reference multiple objects in multiple servers 130. FIG. 1 shows explicitly the one-to-one relationship between object delegate 110 and proxy 120, and the one-to-n relation between the proxy 120 and servers 130.

The proxy specification 112 in FIG. 1 may be represented by the table shown in FIG. 2. Proxy specification 112 includes a column for the name of the Object Delegate, and a column for the corresponding proxy. Recall from FIG. 1 that each object delegate only has one corresponding proxy.

The block diagram of FIG. 3 shows a prior art computer system 300. Computer system 300 includes a first computer system 310, and any suitable number of other computer systems 320, 330, . . . , 340. We assume for this example that each of computer systems 320, 330, . . . , 340 includes a copy of an object. Thus, computer system 320 includes an object 322. Computer system 330 includes an object 332 that is a copy of object 322. Computer system 340 includes an object 342 that is a copy of objects 322 and 332. Computer system 310 includes a proxy object 312 that routes object requests to the appropriate copy of the object in the other computer systems. When an object request 305 is received by computer system 310, the proxy specification 112 in FIG. 2 is consulted to determine which proxy corresponds to the request. As shown in FIG. 2, a PlaceOrder object delegate corresponds to proxy O1, which is shown as 312 in FIG. 3. The proxy 312 must then determine the appropriate object copy to which the request should be routed.

In networked computer systems, there are typically client objects and server objects. A client object is an object that calls a different object that is referred to as a server object. A server object is an object that is called by a client object. Note that the terms client and server are sometimes used in an absolute sense, such as web browsers being clients for web servers. However, the terms client and server as used herein denote the direction of the call, without any specific label being applied to any specific computer system. Thus, a proxy object 312 that receives an object request 305 is a server of the object request, but becomes a client when it sends the client request to the corresponding object copy (such as object 322 in computer system 320).

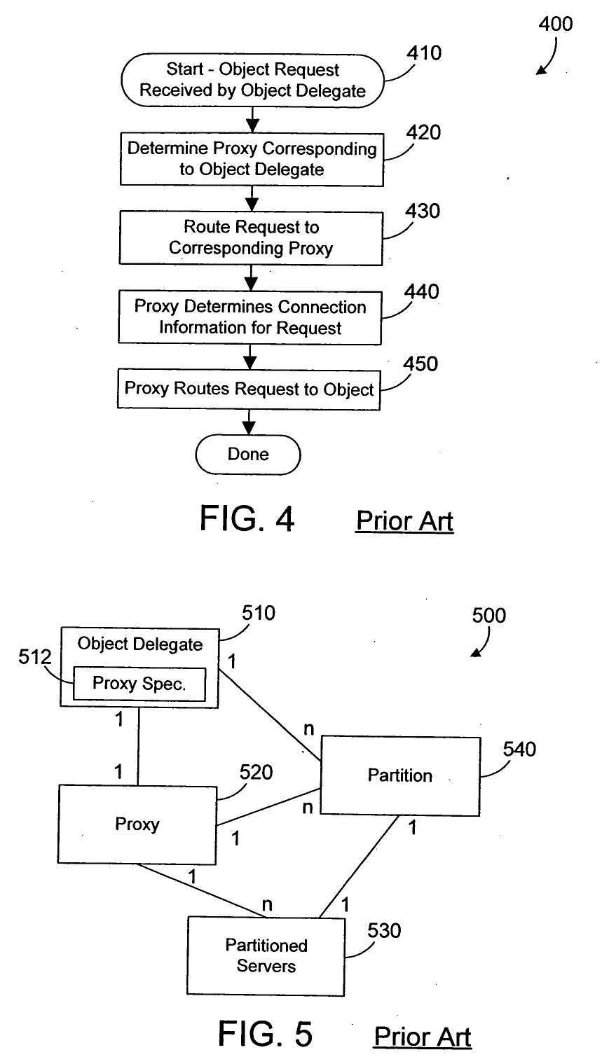

Referring now to FIG. 4, a prior art method 400 shows the steps performed for remote invocation of an object in system 300 in FIG. 3. Method 400 starts when an object request is received by an object delegate (step 410). The proxy corresponding to the object delegate is determined (step 420). As explained above, this is done by consulting the proxy specification shown in FIGS. 1 and 2. The request is then routed to the corresponding proxy (step 430). The proxy determines the connection information for the request (step 440). The proxy then routes the request to the appropriate object (step 450).

Prior art system 300 shown in FIG. 3 and the corresponding method 400 shown in FIG. 4 suffer from two significant problems. First, because the objects 322, 332, . . . , 342 are copies of the same object, there must be a mechanism in place to synchronize the state of these objects. As the number of objects grows, the cost of keeping all of the copies synchronized becomes a greater performance penalty. Second, because there is a single proxy object 312 for all the copies 322, 332, . . . , 342, the proxy 312 must include logic to determine which copy should receive the object request 305. This is done in step 440 in FIG. 4. If the proxy object 312 happens to route the object request 305 to the wrong object copy, there must then be a mechanism to forward the object request 305 to the correct object copy, which also provides a significant performance penalty. The result is that the performance penalty of maintaining multiple object copies is high, and the performance penalty of routing all object requests through a single proxy to multiple object copies is also high. The result is a system that provides relatively poor performance for remote object invocation.

Another prior art computer system 500 is shown in block diagram form in FIG. 5. This computer system 500 includes an object delegate 510 with its proxy specification 512. Computer system 500 also includes a proxy 520 that corresponds to the object delegate 510, and multiple partitions 540. For each partition, there is a corresponding partitioned server 530. The partitioning of a computer system as shown in FIG. 5 does not help the problems shown in FIG. 3. In fact, the problems are made worse by the different partitions. For example, lets assume that the computer systems 310, 320, 330, . . . , 340 in FIG. 3 are each in a different partition. The same problems exist, but now must deal with inter-partition communication. For this reason, the known problems discussed above with respect to FIG. 3 apply to computer system 500 in FIG. 5 as well.

2.0 Description of the Preferred Embodiments

The preferred embodiments presented herein solve the problems in the prior art by providing a method for performing remote invocations in a way that does not require synchronization of data between object copies, and in a way that caches connection information so repeated remote invocations may be performed from the information in the local cache, thereby saving considerable time and system resources during remote object invocation.

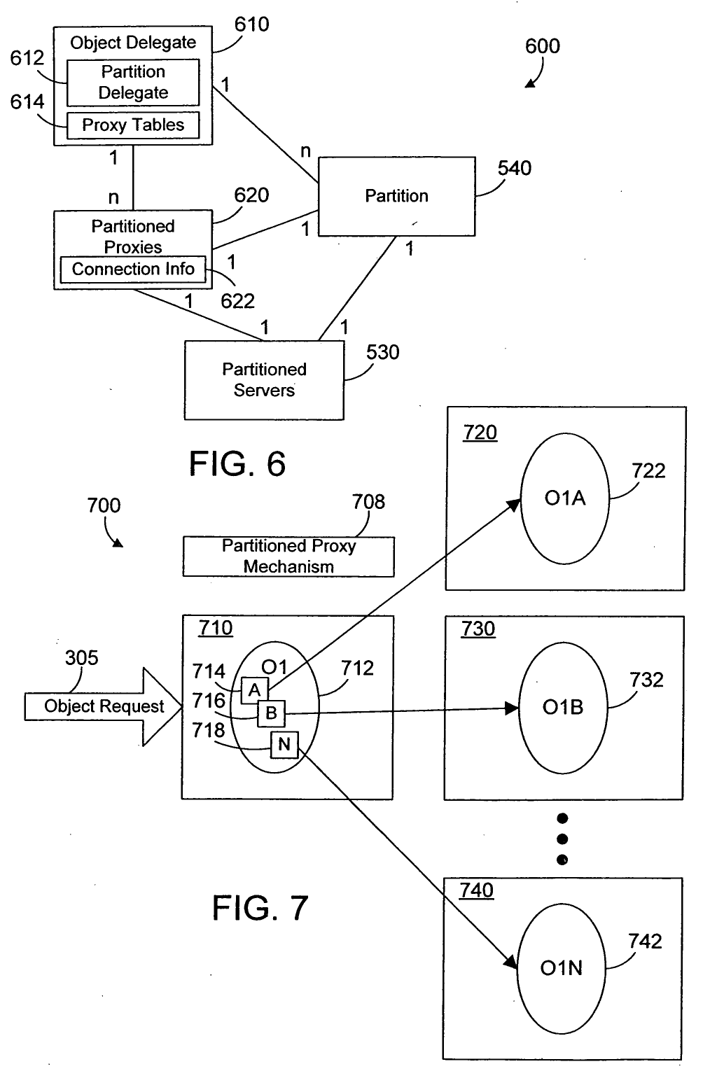

Referring to FIG. 6, a partitioned computer system 600 in accordance with the preferred embodiments includes an object delegate 610 that includes a partition delegate 612 and proxy tables 614. There are multiple partitions 540 that correspond to each object delegate 610. Each partition 540 has a corresponding partitioned server 530. There are also multiple partitioned proxies 620 that correspond to each object delegate 610, with each partitioned proxy 620 including connection information 622 that indicates how to route messages to the corresponding partitioned server 530. Comparing computer system 600 in FIG. 6 to prior art computer system 500 in FIG. 5 reveals some of the significant features of computer system 600. In computer system 500, there is one proxy 520 for n partitioned servers 530. This requires logic within the proxy for determining which partitioned server 530 should receive an object request. Computer system 600, in contrast, provides multiple partitioned proxies 620 that each correspond to a partitioned server 530. This provides a one-to-one correlation between partitioned proxies 620 and partitions 540, and between partitioned proxies 620 and partitioned servers 530. By providing a dedicated partitioned proxy for each partition and partitioned server, the partitioned proxy 620 may locally cache connection information for its corresponding partitioned server, allowing very quickly routing a remote object invocation to its appropriate partitioned server.

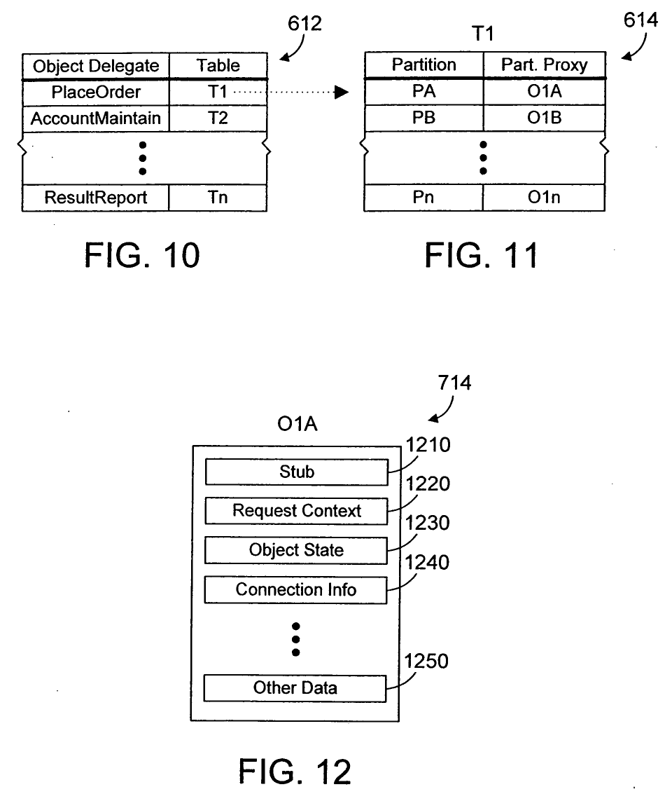

In prior art system 500 in FIG. 5, there is a one-to-one correlation between an object delegate 510 and its corresponding proxy 520. In computer system 600 in FIG. 6, the relationship between object delegate 610 and partitioned proxies 620 is a one-to-n relationship. This requires logic within the object delegate 610 to determine which partitioned proxy 620 corresponds to an object request. Each object delegate 610 includes a partition delegate 612 that identifies from the object request a particular proxy table 614 to use for routing the request. The proxy tables 614 identify which partitioned proxy 620 should receive the request. When the request is routed to the appropriate partitioned proxy 620, it looks at locally cached connection information 622 to determine how to route the request. By caching the connection information 622 within a partitioned proxy, the performance of remote object invocation is significantly improved. The partitioned delegate 612 and proxy tables 614 are shown in more detail in FIGS. 10 and 11.

FIG. 7 shows one particular implementation for a networked computer system 700 that is within the scope of computer system 600 shown in FIG. 6 in accordance with the preferred embodiments. Computer system 700 includes a first computer system 710 coupled via a network connection to a plurality of other computer systems, shown in FIG. 7 as computer systems 720, 730, . . . , 740. We assume that each computer system shown in FIG. 7, namely 710, 720, 730, . . . , 740 represents a different partitioned server (530 in FIG. 6). Computer system 710 includes an object 712 that includes multiple partitioned proxies, shown in FIG. 7 as objects 714, 716, . . . , 718. Object 712 preferably represents an object delegate 610 shown in FIG. 6, and the objects 714, 716, . . . , 718 preferably represent the partitioned proxies 620 in FIG. 6. In the most preferred implementation, there is a separate partitioned proxy for each partitioned server that includes a copy of the corresponding object. In FIG. 7, each computer system 720, 730, . . . , 740 includes a copy of the same object. Thus, computer system 720 includes a corresponding object 722; computer system 730 includes a corresponding object 732 that is a copy of object 722; and computer system 740 includes a corresponding object 742 that is a copy of objects 722 and 732. While only computer systems that include copies of the object are shown in FIG. 7, there may be other computer systems on the network that do not contain a copy of the object. In other words, each computer system on the network need not contain a copy of the object, but there is preferably a partitioned proxy for each partitioned server that includes a copy of the object.

Note that computer system 700 also includes a partitioned proxy mechanism 708 that creates the object copies in the partitioned servers, creates the corresponding partitioned proxies, and creates the corresponding partition delegate and proxy tables. Partitioned proxy mechanism 708 is the mechanism that sets up the computer system 700 for remote object invocation within the scope of the preferred embodiments, and may reside in any computer system on the network in FIG. 7.

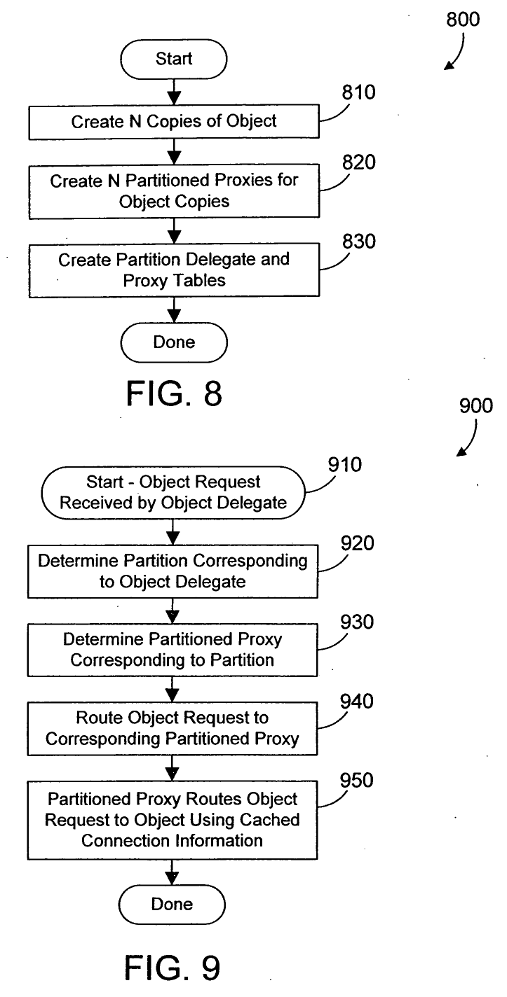

FIG. 8 shows a method 800 for configuring a networked computer system to use partitioned proxies in accordance with the preferred embodiments. Method 800 is preferably performed by the partitioned proxy mechanism 708 in FIG. 7. Method 800 begins by creating N copies of an object (step 810), preferably in N different partitions. Next, N partitioned proxies are created, one for each object copy (step 820). Each partitioned proxy includes a local cache for storing connection information. Once a partitioned proxy performs a remote invocation for the first time, the connection information is stored in the local cache, thereby making future remote object invocations very fast by accessing the connection information in the local cache instead of building a connection path each time a remote object is invoked. At this point, a partition delegate and corresponding proxy table(s) are created (step 830). Once method 800 is complete, the computer system is ready for remote object invocation using the partitioned proxies.

Referring to FIG. 9, a method 900 is performed to route an object request to a partitioned proxy in accordance with the preferred embodiments. Method 900 begins when an object request is received by an object delegate (step 910). The partition corresponding to the object delegate is determined (step 920). The partitioned proxy that corresponds to the partition is then determined (step 930). The object request is then routed to the corresponding partitioned proxy (step 940). The partitioned proxy then routes the object request to the corresponding object, using locally cached connection information, if available (step 950). In the preferred embodiments, each partitioned proxy includes a cache that stores connection information for accessing a given object. The first time a particular remote object is invoked, the partitioned proxy will have to do the work of determining the appropriate connection information for routing the request. This connection information is cached in the partitioned proxy so the partitioned proxy can route subsequent remote requests for the same object using the cached connection information, which greatly speeds the remote object invocation.

One example of a networked computer system that could greatly benefit from the partitioned proxies of the preferred embodiments is a computer system for trading stocks. Let's assume that such a computer system includes a PlaceOrder object that is used to place an order for any of 2,000 stocks that are listed on a particular stock exchange. In the prior art system shown in FIG. 5, a single proxy object would be responsible for all orders for any of the 2,000 stocks. There may be multiple copies of the PlaceOrder object in partitioned servers, but the routing of each order would have to go through a single PlaceOrder proxy object. The time required for the single proxy object to determine which of the partitioned servers should receive the request, to determine the connection information for the corresponding partitioned server, and to route the object request to the appropriate object in the corresponding partitioned server will take a long time for each and every object request. The preferred embodiments eliminates these overhead and system performance problems by providing partitioned proxies that include a local cache of connection information.

For the example above with a computer system for trading 2,000 different stocks, we assume there exists 2,000 different partitioned servers, one per stock. Each of the 2,000 partitioned servers includes a copy of the PlaceOrder object. The state information for these 2,000 object copies need not be synchronized assuming there is no overlap between these object copies, which means that each object handles a request of a different type. Thus, if each PlaceOrder object is given the responsibility for order placement for one and only one of the 2,000 stocks, each object copy of the PlaceOrder object will not have to be synchronized with other copies of the PlaceOrder object because none of these objects share data with any other of these objects. By giving each partitioned server a different, non-overlapping responsibility for requests of a unique type, the need for synchronizing between so many object copies is eliminated. Thus, one copy of the PlaceOrder object may be dedicated to handling orders for IBM stock; another copy may be dedicated to handling orders for Microsoft stock; and so forth.

Another significant advantage of the preferred embodiments is the caching of connection information in each partitioned proxy. The first time a partitioned proxy receives a remote invocation for a particular object, the partitioned proxy does all the work of determining the connection information for routing the object request to the appropriate partitioned server that includes the corresponding copy of the object that needs to receive the object request. Once the partitioned proxy determines this connection information, this connection information is stored in a cache within the partitioned proxy. By caching the connection information in a local cache, the partitioned proxy can route subsequent requests to the same object very quickly to the corresponding object that needs to service the requests without the overhead of determining each time the appropriate connection information for routing the request. The partitioned proxies combined with the local caches of connection information provide a significant performance increase for remote object invocation. Actual tests have been run which show a 15× increase in remote object invocation performance using the partitioned proxies that include local caches as described herein.

In the simple example above, we assume 2,000 partitioned servers for each of the 2,000 different stocks that may be traded. Note, however, that there may be some stocks that have a significantly higher rate of trade than other stocks, and may therefore required multiple partitioned servers to serve the same stock. Let's assume that the top five stocks of the 2,000 required two partitioned servers each to handle the trading volume for these stocks. In this situation there would be ten partitioned server for these top five stocks (two apiece), with 1,995 partitioned servers for the remaining 1,995 stocks, for a total of 2,005 partitioned servers for the 2,000 stocks. In this case, there will generally be a mechanism for synchronizing the object state between the object copies in the different partitioned servers that service orders for the same stock. This simple example shows that the number of partitioned servers need not directly correspond to the number of different items (i.e., stocks in this example), as shown by the example above where 2,005 partitioned servers (and therefore, object copies) are used to service requests for 2,000 different stocks.

One specific implementation of the partition delegate 612 and the proxy tables 614 in FIG. 6 are shown in FIGS. 10 and 11. The partition delegate 612 includes a listing of object delegates to corresponding tables that include partition and partitioned proxy information. If we assume the PlaceOrder object is invoked, table 612 in FIG. 10 shows that table T1 is the proxy table that corresponds to the PlaceOrder object, as shown by the dotted arrow pointing to table 614 in FIG. 11. In the proxy table 614, a partition key is correlated to each partitioned proxy. Thus, knowing the partition allows determining from the proxy table 614 the partitioned proxy that corresponds to the partition. For the example of the PlaceOrder object delegate and Partition A, the corresponding partitioned proxy is object O1A, which corresponds to the partitioned proxy 714 in FIG. 7.

The tables in FIGS. 10 and 11 show how the cache is a “multi-level” cache. In the first level shown in FIG. 10, the object delegate is correlated to the corresponding table in FIG. 11, which is the second level that includes partition and partitioned proxy information. Each entry in the multi-level cache can be represented as (ObjectDelegate, (partition, partitioned proxy)). By providing such a multi-level cache, the connection information stored in a partitioned proxy's local cache may be easily retrieved for subsequent invocations of the same remote object, thereby making the performance of the remote object invocations much greater than is possible using prior art techniques.

One example of suitable contents of the partitioned proxy 714 in FIG. 7 is shown in FIG. 12. Partitioned proxy 714 preferably includes a stub 1210 that points to the corresponding object (722 in FIG. 7), request context information 1220, object state 1230, connection information 1240, and other data 1250. While the partitioned proxy may include any suitable information that needs to be stored locally, the partitioned proxy may function adequately by storing only the stub 1210 and the connection information 1240. By caching the connection information 1240 within the partitioned proxy 714, the partitioned proxy can quickly route remote object requests to their corresponding remote objects.

The partitioned proxies and the cache of connection information is stored in each client. If partitioned servers are down, moved, or restarted, the caches that contain connection information will be invalidated and updated through routing to get the latest connection information. After the first time an object is successfully invoked, the connection information for the object is cached at the client. The local cache on the client will be valid until server partitions change, at which point the local cache will be invalidated, and eventually updated with new connection information as the connections are determined anew.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of tangible computer-readable signal bearing media used to actually carry out the distribution. Examples of suitable tangible computer-readable signal bearing media include: recordable type media such as floppy disks and CD RW (e.g., 195 of FIG. 1), and transmission type media such as digital and analog communications links that tangible embody the invention.

The preferred embodiments provide the ability to improve the performance of remote object invocation by up to fifteen times. By providing a partitioned proxy for each partitioned server, and by caching the connection information for each partitioned server within its corresponding partitioned proxy, most remote invocations may be quickly and efficiently routed to the corresponding partitioned server using the local cache data. In addition, by dividing up the responsibility between object copies to non-overlapping areas, the need to synchronize the object state of object copies is eliminated.

The preferred embodiments disclose a totally different way to cache in the client side the object delegate, which includes partitioned proxies that include connection information that tells how to connect to the real object in clusters of servers. This client-side caching of connection information eliminates the need for server-side object synchronization, which avoids the problems associated with stale data in a server cache. By caching connection information in partitioned proxies on the client side, the client knows how to reach the correct object state faster without any possibility of stale data. This is a huge improvement for companies and businesses that cannot tolerate any stale data on the server side.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A networked computer system comprising:
a plurality of computer systems coupled together via a network, wherein each of the plurality of computer systems contains a copy of a specified object; and
a first computer system that includes a plurality of partitioned proxies that each reference a different copy of the specified object, each partitioned proxy accessing a cache that includes connection information regarding how to access a corresponding copy of the specified object.

2. The networked computer system of claim 1 wherein the cache includes connection information for routing an object request to the corresponding copy of the specified object.

3. The networked computer system of claim 1 wherein the cache correlates an object delegate to a corresponding partition table.

4. The networked computer system of claim 3 wherein the corresponding partition table correlates a partition to a corresponding one of the plurality of partitioned proxies.

5. The networked computer system of claim 1 wherein each copy of the specified object handles requests of a unique type, eliminating any need for synchronizing state data between copies of the specified object.

6. The networked computer system of claim 1 further comprising a partitioned proxy mechanism that creates the copies of the specified object and that creates the corresponding plurality of partitioned proxies.

7. A computer-implemented method for remote object invocation, the method comprising the steps of:
creating a plurality of copies of a specified object in a plurality of computer systems; and
creating a plurality of partitioned proxies that each reference a different copy of the specified object, each partitioned proxy accessing a cache that includes connection information regarding how to access a corresponding copy of the specified object.

8. The method of claim 7 wherein the cache includes connection information for routing an object request to the corresponding copy of the specified object.

9. The method of claim 7 wherein the cache correlates an object delegate to a corresponding partition table.

10. The method of claim 9 wherein the corresponding partition table correlates a partition to a corresponding one of the plurality of partitioned proxies.

11. The method of claim 7 wherein each copy of the specified object handles requests of a unique type, eliminating any need for synchronizing state data between copies of the specified object.

12. The method of claim 7 further comprising the steps of:
(A) receiving an object request;
(B) determining which of the plurality of partitioned proxies correspond to the object request;
(C) routing the object request to the partitioned proxy determined in (B); and
(D) the partitioned proxy determined in (B) routing the object request to a corresponding copy of the specified object using the connection information stored in the cache.

13. A computer-implemented method for remote object invocation in a networked computer system that includes a plurality of computer systems coupled together via a network, wherein each of the plurality of computer systems contains a copy of a specified object. the networked computer system further including a first computer system that includes a plurality of partitioned proxies that each reference a different copy of the specified object, each partitioned proxy accessing a cache that includes connection information regarding how to access a corresponding copy of the specified object, the method comprising the steps of:
(A) receiving an object request;
(B) determining which of the plurality of partitioned proxies correspond to the object request;
(C) routing the object request to the partitioned proxy determined in (B); and
(D) the partitioned proxy determined in (B) routing the object request to a corresponding copy of the specified object using the connection information stored in the cache.

14. A program product comprising:
(A) a partitioned proxy mechanism that creates a plurality of partitioned proxies that each reference a different copy of a specified object in a plurality of computer systems coupled together via a network, wherein each of the plurality of computer systems contains a copy of the specified object, each partitioned proxy accessing a cache that includes connection information regarding how to access a corresponding copy of the specified object; and
(B) computer-readable signal bearing media bearing the partitioned proxy mechanism.

15. The program product of claim 14 wherein the computer-readable signal bearing media comprises recordable media.

16. The program product of claim 14 wherein the computer-readable signal bearing media comprises transmission media.

17. The program product of claim 14 wherein the cache includes connection information for routing an object request to the corresponding copy of the specified object.

18. The program product of claim 14 wherein the cache correlates an object delegate to a corresponding partition table.

19. The program product of claim 18 wherein the corresponding partition table correlates a partition to a corresponding one of the plurality of partitioned proxies.

20. The program product of claim 14 wherein each copy of the specified object handles requests of a unique type, eliminating any need for synchronizing state data between copies of the specified object.
